(19) United States
(12) Patent Application Publication
(10) Pub. No.: US 2005/0166218 A1
(43) Pub. Date: Jul. 28, 2005

(54) Magneto-optical recording medium and method for producing the same

(75) Inventors: Mineo Moribe, Kawasaki (JP); Takahiro Umada, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/085,396

(22) Filed: Mar. 21, 2005

Related U.S. Application Data
(63) Continuation of application No. PCT/JP03/03897, filed on Mar. 27, 2003.

(30) Foreign Application Priority Data
Dec. 24, 2002 (JP) 2002-371759

(51) Int. Cl. G11B 7/24

(52) U.S. Cl. 720/718

(57) ABSTRACT

A magneto-optical recording medium (D1) includes a soft magnetic layer (1), a groove forming layer (3), and a magneto-optical recording layer (4), successively laminated on a substrate (1). The substrate (1) is made of resin. At least a part of the surfaces of the substrate 1 held in contact with the soft magnetic layer (2) has a surface roughness of no less than 4 nm, thereby improving adhesion between the substrate (1) and the soft magnetic layer (2). Since the substrate (1) is made of resin, the production cost can be reduced.

### TECHNICAL FIELD

The present invention relates to an information-rewritable magneto-optical recording medium, and to a method for producing the same.

### BACKGROUND ART

An example of method for recording information onto a magneto-optical recording medium is magnetic field modulation. For recording information by the magnetic field modulation, a magnetic field corresponding to the information to be written is applied to a target portion of a magneto-optical recording medium under irradiation of a laser beam. The magneto-optical recording medium should preferably be designed to allow efficient use of the magnetic field.

A magneto-optical recording medium suitable for magnetic field modulation is known which has a soft magnetic layer. Such a magneto-optical recording medium is disclosed, for example, in JP-A 03-105741. The magneto-optical recording medium disclosed in this publication comprises a soft magnetic layer, a groove forming layer, a magneto-optical recording layer, and a protective layer, successively laminated on an aluminum substrate. The magneto-optical recording layer is a layer for perpendicular magnetization. Information is recorded by irradiating a laser beam and applying a magnetic field to control the magnetization orientation of the magneto-optical recording layer. The soft magnetic layer is made, for example, of Ni—Fe alloy. Unlike the magneto-optical recording layer, the soft magnetic layer is magnetized in a direction parallel to the plane of the soft magnetic layer. The soft magnetic layer may be formed on the substrate by sputtering.

In the prior art magneto-optical recording medium, the magnetic field generated by a magnetic head facing the protective layer permeates through the protective layer, the magneto-optical recording layer, and the groove forming layer. Then, the magnetic field travels in the soft magnetic layer in a direction parallel to that layer and returns to the magnetic head via the groove forming layer, the magneto-optical recording layer, and the protective layer. In this way, the magnetic field forming a closed loop works efficiently on the recording target for effectively recording information.

According to the above prior art, the substrate is made, for example, of aluminum for good adhesion to the soft magnetic layer. However, aluminum is a relatively expensive material, consequently resulting in a cost increase in producing the magneto-optical recording medium. Further, the soft magnetic layer is formed by sputtering, which requires high facility running and maintenance cost. Moreover, adhesion of a soft magnetic layer material to the substrate is not necessarily good to result in poor production efficiency.

### DISCLOSURE OF THE INVENTION

An object of the present invention is to provide a magneto-optical recording medium that can resolve or reduce the problems referred to above, while also providing a method for producing it.

A first aspect of the present invention provides a magneto-optical recording medium comprising a soft magnetic layer, a groove forming layer, and a magneto-optical recording layer, successively laminated on a substrate. The substrate is made of resin, and at least part of surfaces of the substrate held in contact with the soft magnetic layer has a surface roughness of no less than 4 nm.

Preferably, the soft magnetic layer, the groove forming layer, and the magneto-optical recording layer are provided on each of both surfaces of the substrate, and the soft magnetic layer covers the entire surfaces of the substrate. The soft magnetic layer preferably has a coverage area larger than a recording surface, and the coverage area is not larger than 85% of the surface area of the substrate.

A second aspect of the present invention provides a magneto-optical recording medium comprising a soft magnetic layer and a magneto-optical recording layer, successively laminated on a substrate. The substrate is made of resin, and at least part of surfaces of the substrate held in contact with the soft magnetic layer is formed with a plurality of grooves and has a surface roughness of no less than 2 nm.

Preferably, the plurality of grooves are formed on each of both surfaces of the substrate, and the soft magnetic and magneto-optical recording layers are provided on each of both surfaces of the substrates.

A third aspect of the present invention provides a method for producing a magneto-optical recording medium which includes a soft magnetic layer, a groove forming layer, and a magneto-optical recording layer, successively laminated on a substrate. The method comprises a first step of molding resin into the substrate having a surface roughness of no less than 4 nm, and a second step of forming the soft magnetic layer by electroless plating.

Preferably, the first step uses stampers adjusted for a surface roughness of no less than 4 nm.

A fourth aspect of the present invention provides a method for producing a magneto-optical recording medium which includes a soft magnetic layer and a magneto-optical recording layer, successively laminated on a substrate, at least part of surfaces of the substrate held in contact with the soft magnetic layer being formed with a plurality of grooves. The method comprises a first step of molding resin into the substrate having a surface roughness of no less than 2 nm, and a second step of forming the soft magnetic layer by electroless plating.

Preferably, the first step uses stampers adjusted for a surface roughness of no less than 2 nm.

Features and advantages of the present invention will become apparent upon reading the following explanation of embodiments of the present invention.

### BRIEF DESCRIPTION OF THE DRAWINGS

FIG. 1 is a cross section showing a magneto-optical recording medium according to an embodiment of the present invention.

FIGS. 2A and 2B are cross sections illustrating steps of a method for producing the magneto-optical recording medium shown in FIG. 1.

FIGS. 3A and 3B are cross sections illustrating other steps of the method for producing the magneto-optical recording medium shown in FIG. 1.

FIG. 4 is a cross section showing a magneto-optical recording medium according to another embodiment of the present invention.

### BEST MODE FOR CARRYING OUT THE INVENTION

A preferred embodiment of the present invention is specifically described below with reference to the drawings.

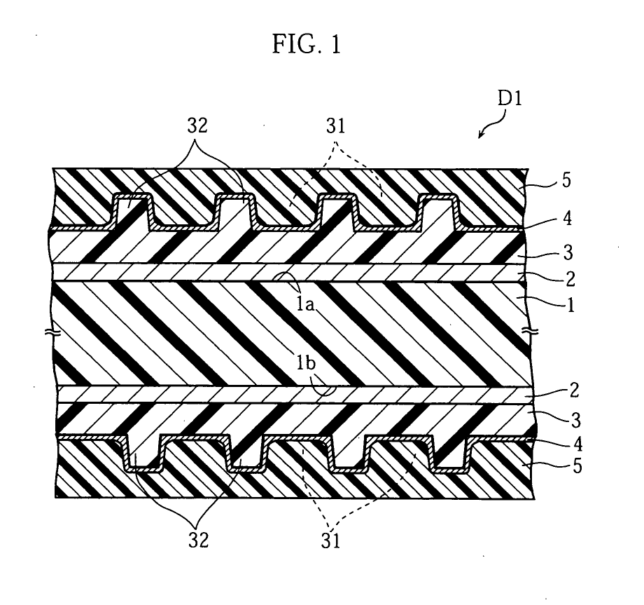

FIG. 1 shows a magneto-optical recording medium according to an embodiment of the present invention. The magneto-optical disk D1 of this embodiment has a soft magnetic layer 2, a groove forming layer 3, a magneto-optical recoding layer 4, and a protective layer 5, successively laminated on each of the top surface 1a and bottom surface 1b of a substrate 1. The magneto-optical disk D1 is symmetric with respect to the substrate 1, including the structures above the top surface 1a of the substrate 1 and below the bottom surface 1b of the substrate 1.

The substrate 1 is made, for example, of polycarbonate and has a doughnut disk shape. The top and bottom surfaces 1a, 1b of the substrate 1 have, for example, a surface roughness of 5 nm. The “surface roughness” herein refers to the “arithmetic mean height” as defined in the Japanese Industrial Standards (JIS) 2001.

The soft magnetic layer 2 is made of a material, such as Fe—Co—Ni alloy, having a high magnetic permeability for undergoing a large change in magnetization with a weak magnetic field. The soft magnetic layer 2 is subject to longitudinal magnetization. The soft magnetic layer 2 is useful for causing the magnetic field generated by the magnetic head to work efficiently on a recording target portion of the magneto-optical recording layer 4. In the present embodiment, the soft magnetic layer 2 covers the entire surfaces of the substrate 2, including the outer and inner circumferential surfaces of the substrate 1 in addition to the top and bottom surfaces 1a and 1b of the substrate 1.

The groove forming layer 3 is made, for example, of ultraviolet curing resin. The groove forming layer 3 has a top or bottom surface which is formed with a plurality of circumferentially extending grooves 31 and lands 32 arranged alternately in the radial direction. Neither “grooves” nor “lands” in this specification conceptually include the magneto-optical recording layer 4. The grooves 31 have a width of 0.5 μm for example and the lands 32 have a width of 0.25 μm for example. The grooves 31 have a depth of 40 nm for example.

Having a large coercive force, the magneto-optical recording layer 4 is a layer on which to record information. The magneto-optical recording layer 4 includes a perpendicular magnetization layer wherein the direction of magnetization is perpendicular to the layer, combined with a dielectric layer and a reflection layer. The magneto-optical recording layer 4 has for example a multilayer structure including an AgPdCuSi layer, an SiN layer, an AgPdCuSi layer, a GdFeCo layer, a TbFeCo layer, and an SiN layer. Such a multilayer structure is preferred for proper recording and reproduction of information. In the present embodiment, the magneto-optical recording layer 4 is formed on each of the top and bottom surfaces 1a, 1b of the substrate 1. Information is recorded in the magneto-optical recording layer 4 at the grooves 31 and lands 32, which allows storage of a large volume of information.

The protective layer 5 is made for example of transparent ultraviolet curing resin. The protective layer 5 serves to prevent the magneto-optical recording layer 4 from becoming worn out or corroded.

The substrate 1 has a thickness for example of 1.2 mm; a soft magnetic layer 2, of 0.8 μm; a groove forming layer 3, of 10 μW; a magneto-optical recording layer 4, of 125 nm; and a protective layer 5, of 15 μm. Each layer of the magneto-optical recording layer 4 has, for example, the following thickness: AgPdCuSi, 10 nm; SiN, 5 nm; AgPdCuSi, 30 nm; GdFeCo, 5 nm; TbFeCo, 25 nm; and SiN 50 nm.

Next, description is made as to an example of production method for the magneto-optical disk D1.

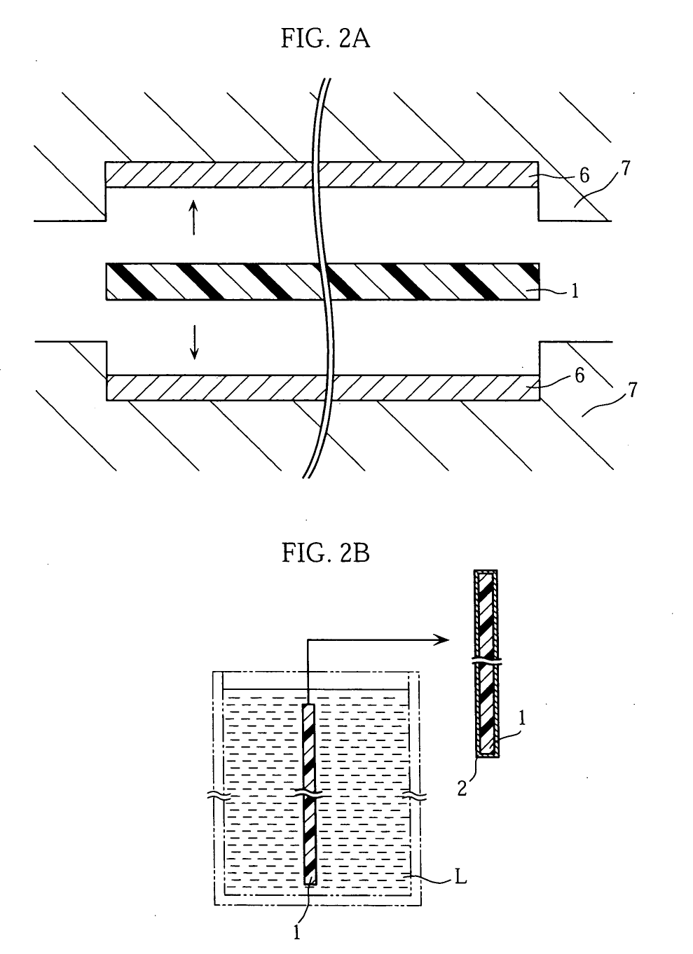

First, a substrate 1 is formed by injection molding of resin. In this step, use is made of a pair of nickel stampers 6 for example, as shown in FIG. 2A. The stampers 6 have been subjected to an etching process for 10 minutes, wherein their surfaces are bombarded with argon ions under a gas pressure of 1.5 Pa and an RF power of 1 kW to yield a surface roughness of 5 nm. The pair of stampers 6 is attached to a metal mold 7. Molten polycarbonate is filled between the stampers 6 and cured to form a substrate 1.

Then, a soft magnetic layer is formed on the entire surfaces of the substrate 1. Electroless plating is utilized in this step. For example, after successively immersing the substrate 1 in a tin chloride solution and a palladium chloride solution, it is immersed in an electroless plating solution L containing Fe-, Ni-, Co-salts and a reductant for 20 minutes to form a soft magnetic layer 2 having the above-described thickness, as shown in FIG. 2B.

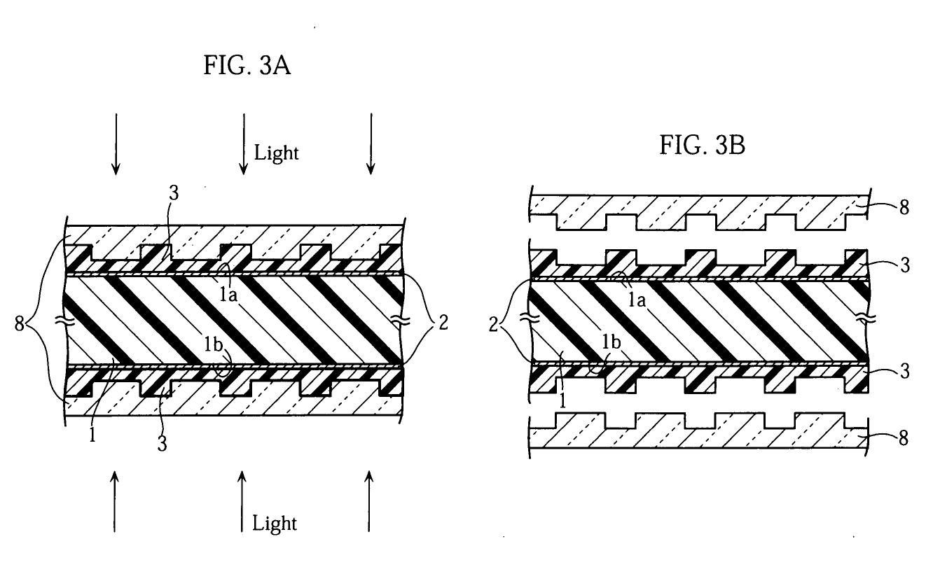

Then, a groove forming layer 3 is formed on the soft magnetic layer 2 on each of the top and boom surfaces 1a, 1b of the substrate 1. In this step, use is made of a pair of transparent quartz glass stampers 8 for example, as shown in FIG. 3A. Each of the transparent stampers 8 has a specific ridge-groove pattern corresponding to the multiple grooves 31 and the multiple lands 32. For forming the groove forming layer 3, a silane coupling agent is applied to the soft magnetic layer 2 to make the surface of the soft magnetic layer 2 adherent, and then uncured ultraviolet curing resin is applied on the soft magnetic layer 2. Each of the paired stampers 8 is arranged on the ultraviolet curing resin with a specified spacing from the soft magnetic layer 2. The ultraviolet curing resin is irradiated with ultraviolet via the transparent stamper 8 for curing. Next, as shown in FIG. 3B, the transparent stampers are removed, whereby the groove forming layer 3 is formed.

Then, a magneto-optical recoding layer 4 is formed on the groove forming layer 3. The magneto-optical recording layer 4 may be formed by successively depositing multiple layers, that are needed to form such a magneto-optical recording layer 4, by sputtering for example. Subsequently, a protective layer 5 is formed on the magneto-optical recording layer 4. The protective layer 5 may be formed by applying uncured ultraviolet curing resin on the magneto-optical recording layer 4 by spin coating for example and irradiating the ultraviolet curing resin with ultraviolet light for curing. As a result of these process steps, a magneto-optical disk D1 is obtained.

Since the substrate 1 is made of resin, it intrinsically does not exhibit good adhesion to the soft magnetic layer 2. However, the substrate 1 has a surface roughness of 5 nm. Therefore, the soft magnetic layer 2 partly enters into the surface micro-pores of the substrate 1 to increase the contact area between the substrate 1 and the soft magnetic layer 2, thereby improving adhesion of the substrate 1 to the soft magnetic layer 2. The inventors of the present invention conducted experiments wherein a plurality of polycarbonate substrates having various levels of surface roughness were prepared for investigating adhesion between the respective substrate and the soft magnetic layer. As a result, it has been confirmed that a substrate having a surface roughness of no less than 4 nm adheres properly to the soft magnetic layer.

The substrate 1, which is made of resin, is less costly than a prior art, substrate which is made of glass or aluminum, which contributes to a reduction of production cost.

The soft magnetic layer 2 is formed by electroless plating, which requires a simpler production facility and a lower running cost than in the case of utilizing a sputtering process. Further, it does not cause any problem with respect to adhesion of the soft magnetic layer 2 to the substrate 1, which also contributes to a production cost decrease.

The following facts have been confirmed by the inventors of the present invention for the double-sided magneto-optical disk described above.

A durability test was conducted by the inventors of the present invention in which Samples 1 to 5 each having a different substrate coverage of the soft magnetic layer were left to stand at high temperature and high moisture of 80° C. and 85% RH for 1000 hours. This test was performed to check whether the substrate suffered a defect in which the moisture absorbed by the substrate was trapped between the substrate and the soft magnet layer (having a low water permeability) to cause semispherical bulging or bumping at the surface of the soft magnetic layer.

The results of the test are shown below in Table 1.

TABLE 1

| | Substrate coverage | Number of |
|---|---|---|
| | with soft magnet | observed |
| Samples | layer (%) | bumps/cm² |
| Sample 1 | 100 | 0 |
| Sample 2 | 95 | 34 |
| Sample 3 | 90 | 7 |
| Sample 4 | 85 | 0 |
| Sample 5 | 80 | 0 |

Sample 1 had a coverage of 100% in which the entire surfaces of the substrate were covered with a soft magnetic layer, as in the magneto-optical disk D1. Samples 2 and 3 had coverage of 95% and 90%, respectively, in which a soft magnetic layer was deposited on the top and bottom surfaces of the substrate, but not on the outer and inner circumferetial surfaces. Samples 4 and 5 had coverages of 85% and 80%, respectively, in which a soft magnetic layer was deposited on the top and bottom surfaces of the substrate, but not on the outer and inner peripheral portions. As shown in Table 1, no bumps were observed in Samples 1, 4, and 5, although bumps were observed in Samples 3 and 4. The test results show that the soft magnetic layer should preferably cover the entire surfaces of the substrate or have an area (a contact area between the substrate and the soft magnetic layer) not larger than 85% of the surface area of the substrate for preventing the above defects. However, even if the soft magnetic layer is made to have an area not larger than 85% of the surface area of the substrate, it should have a larger area than the recording portion of the magneto-optical recording layer, for realizing effective recording of information.

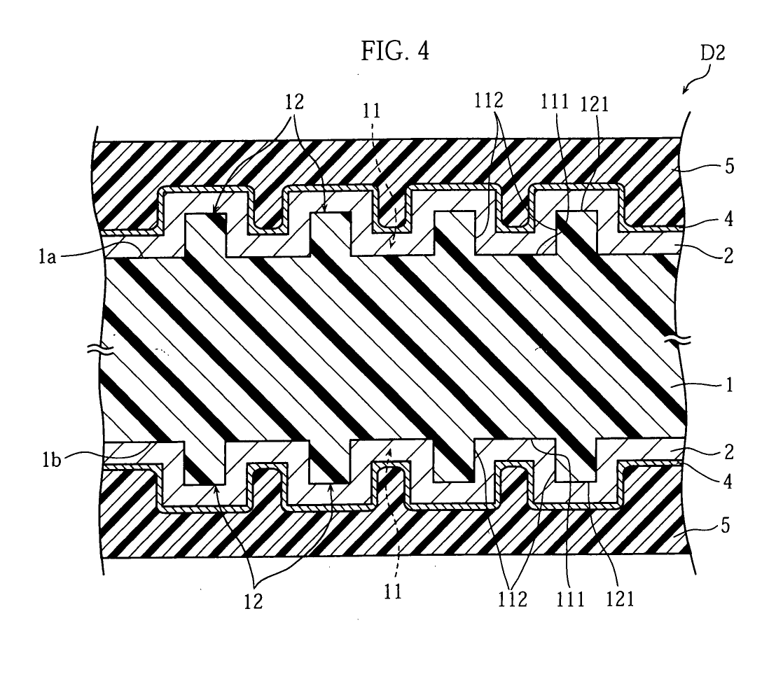

A magneto-optical recording medium according to another embodiment of the present invention is described below with reference to FIG. 4. In FIG. 4, the elements which are identical or similar to those of the preceding embodiment above are given the same reference numbers. The magneto-optical disk D2 of this embodiment has a substrate 1 that is different in shape from that of the foregoing embodiment.

The substrate 1 has top and bottom surfaces 1a, 1b each of which is formed with a plurality of circumferentially extending grooves 11 and lands 12 that are alternate with each other in the radial direction. Therefore, the magneto-optical disk D2 does not have a layer equivalent to the groove forming layer 3 of the foregoing embodiment. The bottom and side surfaces 111 and 112 of the grooves 11 have a surface roughness of 2 nm for example. The flat surfaces 121 forming the lands 12 also have a surface roughness of 2 nm for example.

An example of production method for the magneto-optical disk D2 is described next.

A substrate 1 is prepared by injection molding using a pair of nickel stampers. The pair of stampers has a specific ridge-groove pattern corresponding to the multiple grooves 11 and the multiple lands 12. The pair of stampers is subjected to an etching process for five minutes, in which the surfaces are bombarded with argon ions under a gas pressure of 1.5 Pa and an RF power of 1 kW to yield a surface roughness of 2 nm. The surface roughness can be controlled by changing the etching time. The shorter the etching time, the lower the surface roughness is. The pair of stampers is attached to a metal mold. Molten polycarbonate is filled between the stampers and cured to form a substrate 1. A soft magnetic layer 2, a magneto-optical recording layer 4, and a protective layer 5 are deposited successively on the substrate 1 in the same manner as in the preceding embodiment, thereby obtaining the magneto-optical disk D2.

The substrate 1 of the magneto-optical disk D2 has a surface roughness of 2 nm for example. The inventors of the present invention have confirmed by a test similar to the one performed in the foregoing embodiment that a substrate 1 having a surface roughness of no less than 2 nm is properly adhered to the soft magnetic layer 2 in the structure of the magneto-optical disk D2. Although made of resin, the substrate 1 and the soft magnetic layer 2 exhibit high adhesion also in the magneto-optical disk D2. Compared with the magneto-optical disk D1, the substrate 1 having a smaller surface roughness is still properly adhered to the soft magnetic layer 2. This is presumably because the grooves 11 and the lands 12 are formed on the surfaces of the substrate 1. Therefore, a so-called anchor effect is obtained in addition to a larger contact area between the substrate 1 and the soft magnetic layer 2.

The present invention is not confined to the embodiments described above. The individual components of the magneto-optical recording medium of the present invention can be modified in various ways. Similarly, the individual process steps for producing the magneto-optical recording medium of the present invention can be modified in various ways.

For example, though the two types of magneto-optical disks described above have a double-sided structure wherein the layers are deposited on the top and bottom surfaces of the substrate, the present invention is applicable to a single-sided structure wherein the layers are deposited only on one side of the substrate. In such a case, the surface roughness needs to be adjusted only on one side of the substrate, and the grooves and lands needs to be formed only on one side of the substrate. Further, the substrate need not be necessarily made of polycarbonate, but may be made of other resin such as epoxy. Information recording need not necessarily be performed both at the grooves and lands of the magneto-optical recording layer, but may be performed only with respect to either one of them.

1. A magneto-optical recording medium comprising a soft magnetic layer, a groove forming layer, and a magneto-optical recording layer, successively laminated on a substrate,
wherein the substrate is made of resin, and at least part of surfaces of the substrate held in contact with said soft magnetic layer has a surface roughness of no less than 4 nm.

2. The magneto-optical recording medium according to claim 1, wherein the soft magnetic layer, the groove forming layer, and the magneto-optical recording layer are provided on each of both surfaces of the substrate.

3. The magneto-optical recording medium according to claim 1, wherein the soft magnetic layer covers entire surfaces of the substrate.

4. The magneto-optical recording medium according to claim 1, wherein the soft magnetic layer has a coverage area larger than a recording surface, the coverage area being not larger than 85% of a surface area of the substrate.

5. A magneto-optical recording medium comprising a soft magnetic layer and a magneto-optical recording layer, successively laminated on a substrate,
wherein the substrate is made of resin, and at least part of surfaces of the substrate held in contact with the soft magnetic layer is formed with a plurality of grooves and has a surface roughness of no less than 2 nm.

6. The magneto-optical recording medium according to claim 5, wherein the plurality of grooves are formed on each of both surfaces of the substrate, and the soft magnetic and magneto-optical recording layers are provided on each of both surfaces of the substrates.

7. A method for producing a magneto-optical recording medium which includes a soft magnetic layer, a groove forming layer, and a magneto-optical recording layer, successively laminated on a substrate, wherein the method comprises:
a first step of molding resin into the substrate having a surface roughness of no less than 4 nm, and
a second step of forming the soft magnetic layer by electroless plating.

8. The method for producing a magneto-optical recording medium according to claim 7, wherein the first step uses stampers adjusted for a surface roughness of no less than 4 nm.

9. A method for producing a magneto-optical recording medium which includes a soft magnetic layer and a magneto-optical recording layer, successively laminated on a substrate, at least part of surfaces of the substrate held in contact with the soft magnetic layer being formed with a plurality of grooves, wherein the method comprises:
a first step of molding resin into the substrate having a surface roughness of no less than 2 nm, and
a second step of forming the soft magnetic layer by electroless plating.

10. The method for producing a magneto-optical recording medium according to claim 9, wherein the first step uses stampers adjusted for a surface roughness of no less than 2 nm.
